(19) United States
(12) Patent Application Publication
(10) Pub. No.: US 2015/0028746 A1
(43) Pub. Date: Jan. 29, 2015

(54) AUGMENTED REALITY GRAPHICAL USER INTERFACE FOR NETWORK CONTROLLED LIGHTING SYSTEMS

(71) Applicant: 3M INNOVATIVE PROPERTIES COMPANY, St. Paul, MN (US)

(72) Inventors: DANIEL A. TEMPLE, CEDAR PARK, TX (US); KENNETH C. REILY, AUSTIN, TX (US); JUN XIAO, AUSTIN, TX (US); KANDYCE M. BOHANNON, CEDAR PARK, TX (US); MARK G. YOUNG, Cedar Park, TX (US); Anne-Maud B. Laprais, Austin, TX (US); Karl J.L. Geisier, Saint Paul, MN (US)

(73) Assignee: 3M INNOVATIVE PROPERTIES COMPANY, St. Paul, MN (US)

(21) Appl. No.: 13/951,810

(22) Filed: Jul. 26, 2013

(51) Int. Cl. H05B 37/02

(52) U.S. Cl. CPC H05B 37/02
USPC 315/129

(57) ABSTRACT

A mobile device having an augmented reality user interface for use in controlling networked light modules. The mobile device can detect via a camera a light module and display an identification of the light module on a user interface such as a touch screen. A user can enter a command via the user interface such as a desired intensity or color for the light module. In response, the mobile device transmits a signal to the light module in order to control the operation of the module based upon the command.

### BACKGROUND

Mobile devices such as cell phones can provide a user with an augmented reality experience. A camera in the cell phone can provide a view of the physical environment on a display device, such as an LCD screen, and augmented reality supplements that view with information about the physical environment. For example, textual descriptions can be overlaid on the view of the physical environment in order to provide the user with more information about the physical environment such as retail establishments within the vicinity of the user. Augmented reality is helpful to provide users with more information via their mobile devices. However, augmented reality tends to only provide static information. Accordingly, a need exists for using augmented reality as a control device for a user to interact with the physical world.

### SUMMARY

A mobile device having a user interface for use in controlling lighting, consistent with the present invention, includes a camera, a display device, and a component for transmitting a control signal. A processor within the mobile device is configured to detect via the camera a light module and display an identification of the light module on the display device. The processor is further configured receive a command relating to control of the light module and transmit a signal to the light module via the component. The signal provides the command to the light module for controlling operation of the light module.

A method for controlling lighting via a user interface on a mobile device having a camera and a display device, consistent with the present invention, includes detecting via the camera a light module and displaying an identification of the light module on the display device. The method further includes receiving a command relating to control of the light module and transmitting a signal to the light module, where the signal provides the command to the light module for controlling operation of the light module.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a network controlled lighting system;

FIG. 2 is a diagram of a light module in a network controlled lighting system;

FIG. 3 is a diagram of a mobile device having an augmented reality user interface for controlling light modules in a network controlled lighting system;

FIG. 4 is a flow chart of a method for controlling light modules in a network controlled lighting system;

FIG. 5 is a user interface for obtaining status information for light modules in a network controlled lighting system;

FIG. 6 is a user interface for providing status and commands for a light module; and

FIG. 7 is a user interface for a user to enter commands to control a light module.

### DETAILED DESCRIPTION

Embodiments of the present invention include an augmented reality (AR) graphical user interface, designed for touch screens on mobile devices equipped with cameras, specific to the control of network accessible light modules. The user interface graphics can be static or animated to identify the light modules within frame. Each highlight is interactive and may be activated to display information or controls for the lighting module. A user can enter commands via the AR user interface to control the operation of the lighting modules. In response, the mobile device wirelessly transmits control signals for the commands to the lighting module.

FIG. 1 is a diagram of a network controlled lighting system 10. System 10 includes light modules 14, 16, and 18, each having a connection with a network 12 such as the Internet or a local area network. A mobile device 20 can use an augmented reality interface to detect the light modules, as represented by communications 22, 26, and 28. Mobile device 20 can send commands to a particular light module, as represented communication 24, to allow a user to control a light module via an augmented reality interface.

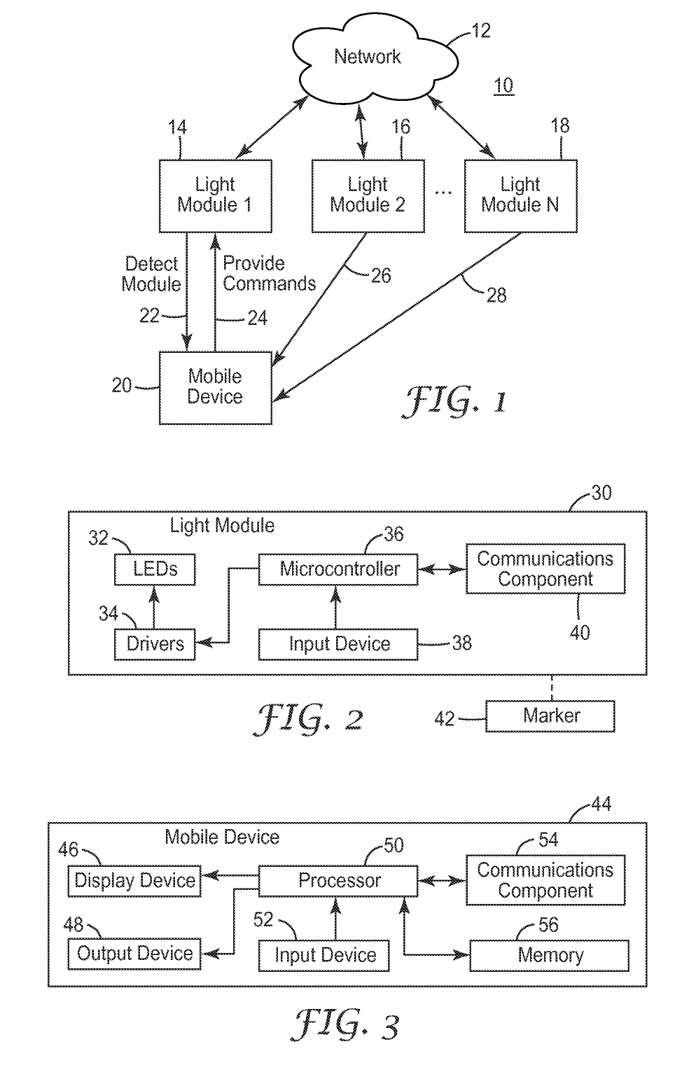

FIG. 2 is a diagram of a light module 30 in a network controlled lighting system. Light module 30 includes one or more light emitting diodes (LEDs) 32 or other types of light sources. A microcontroller 36, such as a processor, can control LEDs 32 via drivers 34. Microcontroller 36 can receive commands via an input device 38 and can also have a communications component 40, such as an LED or network connection, for receiving and sending information. A marker 42 identifies light module 30 and can be located on or proximate light module 30. Marker 42 can be implemented with a physical marker, for example a Quick Response (QR) code or other printed indicia. Alternatively, light module 30 can be identified by a modulated light signal from LEDs 32 instead of a physical marker.

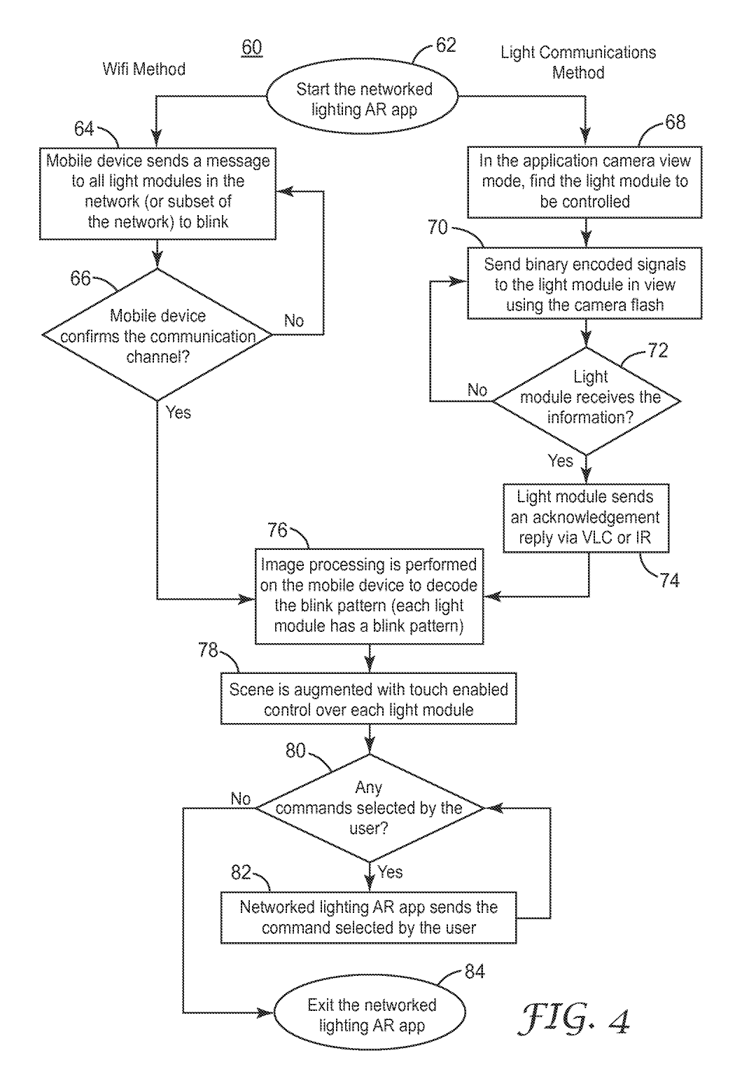

FIG. 3 is a diagram of a mobile device 44 having an augmented reality user interface for controlling light modules in a network controlled lighting system. Mobile device 44 has a display device 46 such as a liquid crystal display (LCD) screen for displaying information, an output device 48 (e.g., speaker) for outputting information, an input device 52 (e.g., microphone, touch screen, digital camera) for receiving information, and a communications component 54, such as an LED or network connection, for receiving and sending information. A processor 50 controls the components of mobile device 44 and can access a memory 56 storing software programs or other information.

FIG. 4 is a flow chart of a method 60 for controlling light modules in a network controlled lighting system. Method 60 can be implemented in software, for example, for execution by processor 50 in mobile device 44. Method 60 includes exemplary subroutines, a WiFi (wireless local area network) method and a light communications method, for identifying light modules when the networked light AR application is started (step 62).

The WiFi method includes mobile device 44 sending a message to all the light modules (e.g., modules 22, 26, 28) or a subset of them to blink (step 64). In this WiFi method, light modules can be discovered and registered with the network at installation. Light module addresses are dynamically generated within a range of addresses. Discovery of the light modules can be accomplished by a server sending multicast messages, such as user datagram protocol (UDP) messages, which should be received by all of the light modules in the network. The light modules send a response including the identification of them, typically a name, back to the server. Now the server has identified the names of all the modules on its network.

Mobile device 44 determines whether it can confirm a communications channel with the light modules (step 66). In particular, when the augmented reality application is launched on mobile device 44, a message is sent to the light modules in the network to start blinking The blink is represented as a binary sequence encoded to correspond to the name of the associated light module on the network. Due to the relatively slow frame rate of a mobile device camera, it is preferred to use a fourth LED channel to send non-visible data from the light modules to the camera via infrared (IR) light. This method will provide a visible light communication (VLC) channel to the camera but will be invisible to people. If a mobile device has an IR filter, blinking a single visible color is an alternative. Blinking with a color in the visible spectrum will allow light modules to be identified and data transfer using both color and binary encoding to increase data rates. At this step, either all light modules start blinking (simultaneously) or each module signals one at a time (sequentially) until the mobile device confirms the communication channel.

The light communications method includes using the camera view mode of mobile device 44 to find a light module to be controlled (step 68). A camera flash on mobile device 44 is used to send binary encoded signals to the light module (e.g., module 14) in view (step 70). The flash on the camera is enabled by the augmented reality application to send binary encoded signals to the light module, which are detectable by the light module ambient sensor implemented as an input device 38. The ambient sensor is used to determine the relative distance of each light module, since modules that are farther away will receive less light thus determining which light module should respond.

Mobile device 44 determines if the light module receives the information (step 72) by detecting an acknowledgement reply from the module (step 74). The light module responds by sending an acknowledgement via VLC or IR back to mobile device 44, followed by an identifier or data. This blinking can be accomplished as in the WiFi method using binary encoded signals.

Once a light module is identified, mobile device 44 performs image processing to decode the blink pattern from the module (step 76). Through the use of an image processing algorithm to decode the blink sequences, the mobile device can interpret which light modules are in its view. With multiple light modules in-frame, the image processing is capable of dividing the image on a frame by frame basis to track and maintain the data stream from each light module.

An exemplary image processing algorithm for step 76 involves the use of color thresholding in which the image captured by the camera in mobile device 44 is divided into smaller groups or clusters of pixels. These groups of pixels can correspond with the light sources the user is trying to control through the AR application. Each group of pixels in the image is assigned an overall color, for example an average or dominant color of the group. The assigned color for the group is then compared to a color map in order to correlate the assigned color with a known color. Segmenting the image according to color in this manner essentially enhances the contrast of the scene in order for the image processing algorithm to more easily differentiate features in the scene. Other image processing algorithms for implementing step 76 are possible.

On the user interface in display device 46 of mobile device 44 the scene displayed is augmented with touch enabled control for the light modules (step 78).

Augmentation of the scene can involve adding touch-enabled controls over each light module icon or other identifier on the user interface. The mobile device also commands the light module to stop blinking at this point, in the case where visible spectrum colors are using for the blinking If IR light is used the blinking patterns may continue to provide a continuous means of data and tracking in the augmented reality frame.

If mobile device 44 receives a command selected by a user (step 80), mobile device 44 sends the command to the selected light module for use in controlling operation of the light module (step 82). The command can be sent using a binary encoded data signal with visible spectrum colors or IR light from mobile device 44. The light module can optionally confirm receipt of the command. If no commands are selected (step 80), mobile device 44 exits the AR application (step 84).

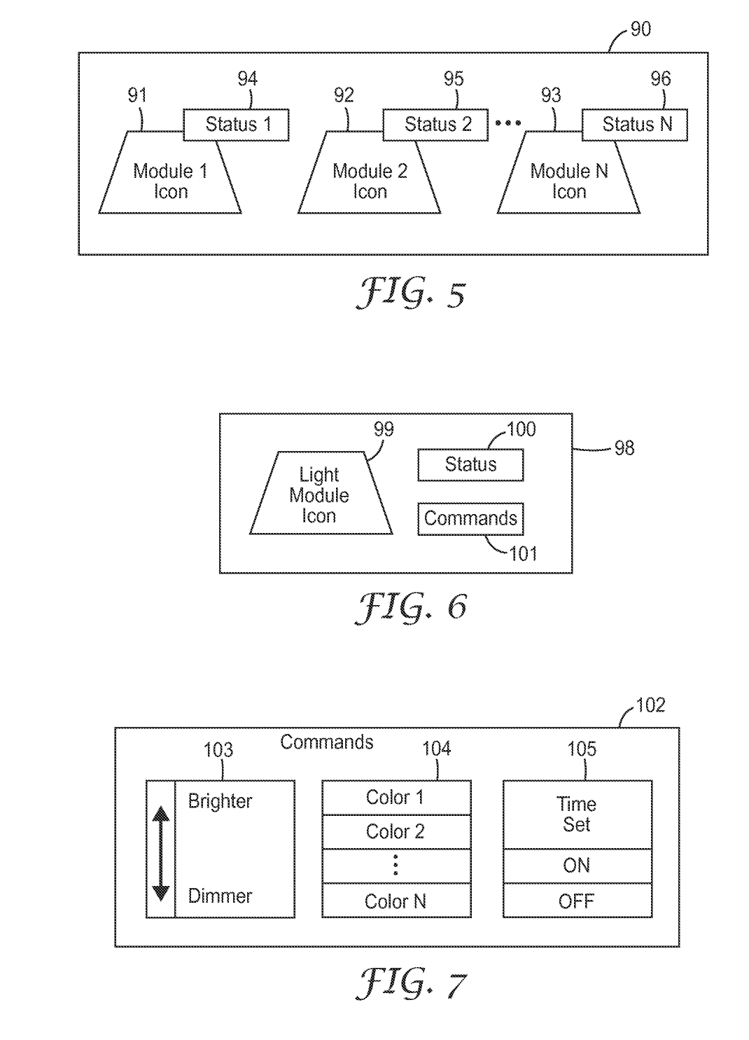

FIGS. 5-7 are exemplary user interfaces for use in controlling light modules. These user interfaces can be provided on display device 46 of mobile device 44.

FIG. 5 is a user interface 90 for obtaining status information for light modules in a network controlled lighting system for the WiFi and light communications methods described above. User interface 90 includes icons 91, 92, and 93 representing identified light modules such as modules 14, 16, 18. Portions 94, 95, and 96 can display the status of identified light modules. The status can include, for example, a color output by the light module and the time remaining (e.g., hours) for the module.

FIG. 6 is a user interface 98 for providing status and commands for a light module such as module 14. Interfaces 90 and 98 can be used with steps 76, 78, 80, and 82 in method 60. User interface 98 can display an icon 99 representing an identified light module to be controlled. A portion 100 can display the status of the light module, and a portion 101 can be used to receive a command from a user for controlling the light module.

FIG. 7 is a user interface 102 for a user to enter commands to control a light module such as module 14. User interface 102 can be implemented with a touch screen as display device 46 for a user to enter the commands. A section 103 can be used to enter a desired intensity of the light module by entering commands for the module to output brighter or dimmer light. A section 104 can be used to enter a desired color output by the light module by selecting a particular desired color identified in section 104. A section 105 can be used to enter desired times when the light module is on or off. For example, the user can set a timer to command the light module to turn on or off after a particular time period or enter times when the light module should turn on or off.

The user interfaces shown in FIGS. 5-7 can be supplemented with additional displayed information including, for example, text and graphics. Other commands for controlling operation of the light modules are also possible.

1. A mobile device having a user interface for use in controlling lighting, comprising:
a mobile device having a camera, a display device, and a component for transmitting a control signal; and
a processor within the mobile device, wherein the processor is configured to:
detect via the camera a light module;
display an identification of the light module on the display device;
receive a command relating to control of the light module; and
transmit a signal to the light module via the component, wherein the signal provides the command to the light module for controlling operation of the light module.

2. The mobile device of claim 1, wherein the processor is configured to detect the light module via a marker associated with the light module.

3. The mobile device of claim 1, wherein the display device comprises a touch screen, and the processor is configured to receive the command via the touch screen.

4. The mobile device of claim 1, wherein the component is an LED, and the processor is configured to transmit the signal via the LED as a binary encoded light signal.

5. The mobile device of claim 1, wherein the component is a network connection, and the processor is configured to transmit the signal via the network connection.

6. The mobile device of claim 1, wherein the processor is configured to display via the display device an icon as the identification of the light module.

7. The mobile device of claim 1, wherein the processor is configured to display via the display device a status of the light module.

8. The mobile device of claim 1, wherein the processor is configured to receive as the command a desired intensity of the light module.

9. The mobile device of claim 1, wherein the processor is configured to receive as the command a desired color of the light module.

10. The mobile device of claim 1, wherein the processor is configured to receive as the command an indication of when the light module is to switch between an on state and an off state.

11. A method for controlling lighting via a user interface on a mobile device having a camera and a display device, comprising:
detecting via the camera a light module;
displaying an identification of the light module on the display device;
receiving a command relating to control of the light module; and
transmitting, via a processor, a signal to the light module, wherein the signal provides the command to the light module for controlling operation of the light module.

12. The method of claim 11, wherein the detecting step comprises detecting the light module via a marker associated with the light module.

13. The method of claim 11, wherein the receiving step comprises receiving the command via a touch screen associated with the mobile device.

14. The method of claim 11, wherein the transmitting step comprises transmitting the signal via an LED as a binary encoded light signal.

15. The method of claim 11, wherein the transmitting step comprises transmitting the signal via a network connection.

16. The method of claim 11, further comprising displaying via the display device an icon as the identification of the light module.

17. The method of claim 11, further comprising displaying via the display device a status of the light module.

18. The method of claim 11, wherein the receiving step comprises receiving as the command a desired intensity of the light module.

19. The method of claim 11, wherein the receiving step comprises receiving as the command a desired color of the light module.

20. The method of claim 11, wherein the receiving step comprises receiving as the command an indication of when the light module is to switch between an on state and an off state.
